(19) United States
(12) Patent Application Publication
(10) Pub. No.: US 2022/0090441 A1
(43) Pub. Date: Mar. 24, 2022

(54) NOISE DAMPENER

(71) Applicant: David Andrew Coulter, Raleigh, NC (US)

(72) Inventor: David Andrew Coulter, Raleigh, NC (US)

(21) Appl. No.: 17/026,242

(22) Filed: Sep. 20, 2020

(51) Int. Cl. E06B 5/20

(52) U.S. Cl. CPC E06B 5/20; E05Y 2900/148; E05Y 2900/132; E05Y 2800/422

(57) ABSTRACT

An apparatus for dampening noise includes a body having a base and arms obliquely extending from the base, an adhesive layer bonded to the body, and a peelable layer covering the adhesive layer. The apparatus can be affixed to an occlusal surface of a door to deaden the noise of the door closing.

### BACKGROUND

### 1. Field of Invention

The present disclosure relates to a noise dampener, and more particularly, to a device that dampens the noise of a collision between two objects.

### 2. Discussion of the Related Art

Most homes, apartments, and living areas have cabinets, drawers, seats, and doors. The opening and closing of these create, in many cases, loud and disturbing noises/vibrations.

In the related art, products have been introduced to reduce or eliminate this noise, however they require disassembly, assembly, and/or installation (with tools) of the product or the cabinets, drawers, etc. Often, work is required on both the product and the object to which it is attached. The installation usually requires costly services or extensive time investment and knowledge.

Thus, there is a need for a device that can be easily installed and that can dampen or eliminate the noise/vibration produced by cabinet doors, drawers, or anything that closes and creates noise.

### SUMMARY

It is an object of the present invention to provide a device to soften the impact of two objects meeting, thereby reducing the sound produced at impact.

It is another object of the present invention to provide a device that can dampen the noise of a closing cabinet, drawer, or door while minimizing interference with the operation of the cabinet, drawer, or door.

It is yet another object of the present invention to provide a device that can be easily attached to the occlusal surface of a cabinet drawer, where it can deaden the impact of the cabinet door closing and collapse to allow the cabinet door to more fully close.

It is yet another object of the present invention to provide a noise deadening device with an adhesive strip and a removable layer so that the device can be stored before it is attached to a surface.

An apparatus for dampening noise is provided. The apparatus includes a body having a base and arms obliquely extending from the base, an adhesive layer bonded to the body, and a peelable layer covering the adhesive layer.

According to an embodiment, the body of the apparatus may be made of foam. The base may be shaped as a rectangular prism. The adhesive layer may be bonded to a lower surface of the base, and the arms may extend from an upper surface of the base. The arms may be spaced apart from each other along the base. A cross section of the arms may narrow as the arms extend from the base. The arms may terminate in chisel ends, spiked ends, or rounded ends. A width of the arms may be the same as a width of the base. The body may be integrally formed.

A method for dampening a noise is also provided. The method includes accessing an apparatus including a body having a base and arms obliquely extending from the base, an adhesive layer bonded to the body, and a peelable layer covering the adhesive layer; removing the peelable layer; and affixing the apparatus to an occlusal surface.

According to an embodiment, the method may further include reducing a length of the apparatus by cutting the apparatus before removing the peelable layer or before affixing the apparatus to the occlusal surface.

Another method for dampening a noise is provided. The method includes causing a user to access an apparatus including a body having a base and arms obliquely extending from the base, an adhesive layer bonded to the body, and a peelable layer covering the adhesive layer; causing the user to remove the peelable layer; and causing the user to affix the apparatus to an occlusal surface.

By affixing the apparatus to the occlusal surface, a noise of a door closing may be deadened.

### BRIEF DESCRIPTION OF THE DRAWINGS

Various embodiments are illustrated by way of example and not limitation in the accompanying drawings, in which like references indicate similar elements. Various objects, features, and characteristics of the present invention will become more apparent to those skilled in the art from a study of the Detailed Description in conjunction with the accompanying drawings.

FIG. 1 is a perspective view of the device according to an embodiment.

FIG. 2 is a side view of the device according to the embodiment of FIG. 1.

FIG. 3 is a side view of the device according to another embodiment.

FIG. 4 is a side view of the device according to yet another embodiment.

FIG. 5 is a side view of the device according to yet another embodiment.

FIG. 6 is an illustration of device according to the embodiment of FIG. 1 installed on an occlusal surface of a cabinet.

The figures depict various embodiments for the purpose of illustration only. Those skilled in the art will readily recognize that alternative embodiments may be employed without departing from the principles of the present invention. The claimed subject matter is intended to cover all modifications, equivalents, and alternatives falling within the scope of the present invention as defined by the appended claims.

### DETAILED DESCRIPTION

The preferred embodiments herein described are not intended to be exhaustive or to limit the invention to the precise form disclosed. They are chosen and described to explain the invention so that others skilled in the art might utilize its teachings.

Reference to “one embodiment” or “an embodiment” means that a particular feature, structure, or characteristic described in connection with the embodiment is included in at least one embodiment of the disclosure. The appearances of the phrase “in some embodiments” are not necessarily referring to the same embodiment, nor are they necessarily referring to separate or alternative embodiments that are mutually exclusive of one another.

The terms “connected,” “coupled,” or any variant thereof includes any connection or coupling between two or more elements, either direct or indirect. The coupling or connection between the elements can be physical, logical, or a combination thereof. For example, two components may be coupled directly to one another or via one or more intermediary channels/components.

Features of various exemplary embodiments of the present disclosure may be combined partially or totally. As will be appreciated by those skilled in the art, various combinations of elements are possible.

Hereinafter, exemplary embodiments of the present disclosure will be described in detail with reference to the accompanying drawings.

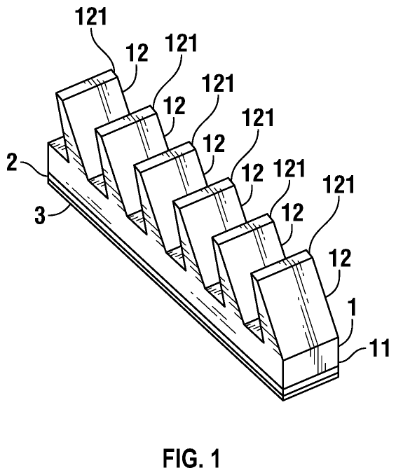

FIG. 1 shows a perspective view of the device according to an embodiment. Referring to FIG. 1, the device includes a body 1, and adhesive layer 2, and a peelable layer 3. The adhesive layer 2 is bonded to the lower surface of the body 1. The peelable layer 3 covers the lower surface of the adhesive layer 2.

The body 1 is preferably made of foam, but may be made of any soft, flexible, resilient material. The body 1 includes a base 11 and a plurality of arms 12. In some embodiments, base 11 is shaped as a rectangular prism. The arms 12 extend from a top surface of the base 11 at an oblique angle, and are spaced apart along the top surface of the base 11. The arms 12 are relatively wide where they extend from the top surface of the base 11 and become narrower moving away from the top surface of the base 11. In the embodiment of FIG. 1, the arms 12 terminate in chisel ends 121.

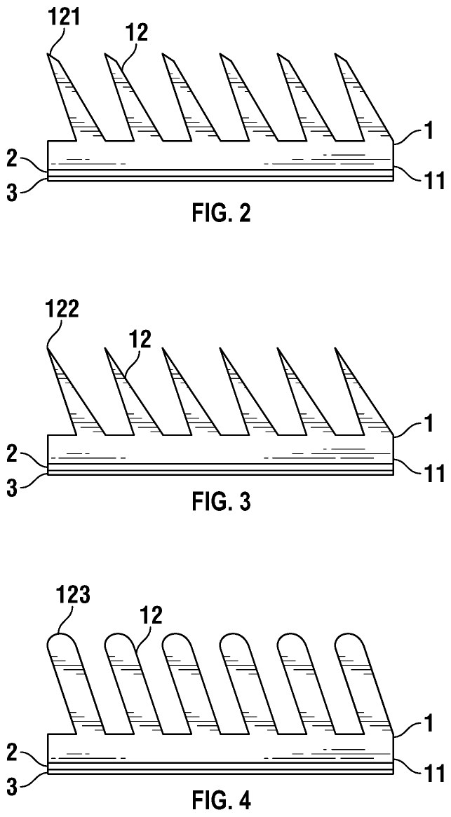

FIG. 2 shows a side view of the embodiment of FIG. 1. In this embodiment, the arms 102 terminate in chisel ends 121.

FIG. 3 shows a side view of an embodiment in which the arms 12 terminate in spiked ends 122. The remaining elements of the embodiment of FIG. 3 are substantially the same as those of the embodiment of FIG. 1, and will not be repeated here for the sake of brevity.

FIG. 4 shows a side view of another embodiment in which the arms 12 terminate in rounded ends 123. The remaining elements of the embodiment of FIG. 4 are substantially the same as those of the embodiment of FIG. 1, and will not be repeated here for the sake of brevity.

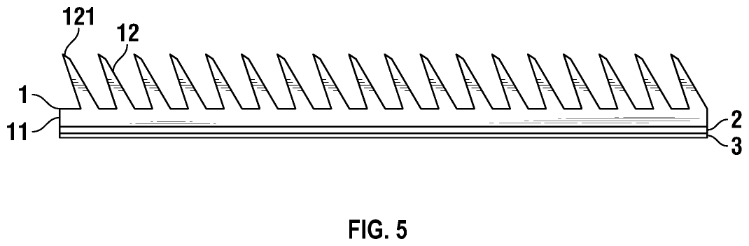

FIG. 5 shows a side view of yet another embodiment. This embodiment is the substantially the same as that of FIG. 1, except that the body 1 has been elongated and the number of arms 12 has been increased. There is no limit to the number of arms 12 the device can have. For example, the device could have 1-18 or more arms 12. Although in the embodiment of FIG. 5 the arms 12 have chisel ends 121, the arms 12 in the elongated device could also have spiked ends 122 or rounded ends 123 as shown in FIGS. 3 and 4, respectively.

The shapes of the ends of the arms shown in the drawings are not intended to be limiting. Rather, the ends of the arms and the arms themselves could take any shape that those skilled in the art would recognize as suitable. It is further contemplated that the base 11 need not be rectangular, but may be oval, an amorphous shape, or any shape that would be recognized as suitable by those skilled in the art. Furthermore, the dimensions of the device could be set based on the desired application. In a preferred embodiment, the device is 1-2 inches long, but may be any length or width suitable for the desired application. Although it is preferable that the device include the adhesive layer 2 and the peelable layer 3, these elements may be replaced with other fastening components without departing from the spirit and scope of the invention.

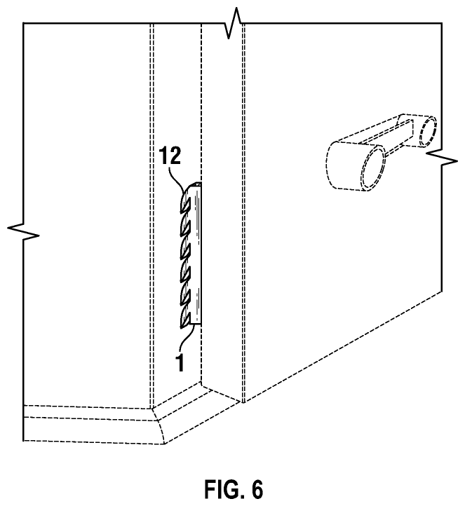

FIG. 6 shows the device according to the embodiment of FIG. 1 being used in one possible application. In this application, the peelable strip 3 has been removed, and the device has been stuck to the side occlusal surface of a cabinet door by the adhesive layer 2 (not shown in FIG. 6). This is only one example of a possible placement of the device. In other examples, the device may be placed on the lower occlusal surface of the cabinet door, the upper occlusal surface of the cabinet door, or even on an occlusal surface of the stationary part of the cabinet.

As the cabinet door closes, the body 1 of the device impacts the stationary occlusal surface of the cabinet. Because the body 1 is made of soft, flexible foam, the noise of the impact is deadened. After the initial contact between the body 1 and the stationary occlusal surface of the cabinet, and as the cabinet door continues to close, the arms 12 flex inward, thus reducing the angle between the arms 12 and the base 11. This flexing of the arms 12 serves to further deaden the noise of the impact, and also allows the cabinet door to close to a greater extent, so that the cabinet door completely closes or nearly completely closes.

When the cabinet door reopens, the arms rise back to their original position, because the foam material of the body 1 is resilient. The resilience of the body 1 allows the device to repetitively deaden impacts from the cabinet door. The device may be capable of handling hundreds of closing events without being worn out or needing replacement.

It should be appreciated that the embodiments of FIGS. 3-5 could also be used in the same application as shown in FIG. 6. If the embodiment of FIG. 5 is used in a cabinet application, the entire device may be used, or a user may cut the device to the desired length. The user may retain the unused portion of the device for a later application.

The device may be used in many other applications according to the same concept illustrated in FIG. 6. For example, the device may be applied to a door, a window, a drawer, a toilet seat, or anything else that closes. The device may be applied on any occlusal surface, and may be of any length or have any number of arms 12. For example, the device may cover only a small portion of the occlusal surface of a door or cover the entire occlusal surface of the door. The user may cut the device to the desired size based on the desired application.

The foregoing description of various embodiments of the claimed subject matter has been provided for the purposes of illustration and description. It is not intended to be exhaustive or to limit the claimed subject matter to the precise forms disclosed. Many modifications and variations will be apparent to one skilled in the art. Embodiments were chosen and described in order to best describe the principles of the invention and its practical applications, thereby enabling those skilled in the relevant art to understand the claimed subject matter, the various embodiments, and the various modifications that are suited to the particular uses contemplated.

What is claimed is:

1. An apparatus for dampening noise, comprising:
a body including a base and arms obliquely extending from the base;
an adhesive layer bonded to the body; and
a peelable layer covering the adhesive layer.

2. The apparatus of claim 1, wherein the body is made of foam.

3. The apparatus of claim 1, wherein the base is shaped as a rectangular prism.

4. The apparatus of claim 1, wherein the adhesive layer is bonded to a lower surface of the base, and the arms extend from an upper surface of the base.

5. The apparatus of claim 1, wherein the arms are spaced apart from each other along the base.

6. The apparatus of claim 1, wherein a cross section of the arms narrows as the arms extend from the base.

7. The apparatus of claim 1, wherein the arms terminate in chisel ends.

8. The apparatus of claim 1, wherein the arms terminate in spiked ends.

9. The apparatus of claim 1, wherein the arms terminate in rounded ends.

10. The apparatus of claim 1, wherein a width of the arms is the same as a width of the base.

11. The apparatus of claim 1, wherein the body is integrally formed.

12. A method for dampening a noise, comprising:
accessing an apparatus including a body having a base and arms obliquely extending from the base, an adhesive layer bonded to the body, and a peelable layer covering the adhesive layer;
removing the peelable layer; and
affixing the apparatus to an occlusal surface.

13. The method of claim 12, further comprising reducing a length of the apparatus by cutting the apparatus before the removing of the peelable layer or before the affixing of the apparatus to the occlusal surface.

14. A method for dampening a noise, comprising:
causing a user to access an apparatus including a body having a base and arms obliquely extending from the base, an adhesive layer bonded to the body, and a peelable layer covering the adhesive layer;
causing the user to remove the peelable layer; and
causing the user to affix the apparatus to an occlusal surface.
